(19) United States
(12) Patent Application Publication
(10) Pub. No.: US 2013/0109222 A1
(43) Pub. Date: May 2, 2013

(54) CONNECTOR RETAINING DEVICE

(71) Applicant: HUI-CHIH CHANG, TAIPEI CITY (TW)

(72) Inventor: HUI-CHIH CHANG, TAIPEI CITY (TW)

(73) Assignee: NUETEQ TECHNOLOGY, INC., TAIPEI CITY (TW)

(21) Appl. No.: 13/492,743

(22) Filed: Jun. 8, 2012

(30) Foreign Application Priority Data
Oct. 28, 2011 (TW) 100220331

(51) Int. Cl. H01R 13/622

(52) U.S. Cl. 439/359

(57) ABSTRACT

A cable connector retaining device sleevedly adaptable over a high definition multimedia interface connector includes at least one engaging member and a housing. The housing includes a plate portion, an abutting portion and a fixing portion. The abutting portion is arranged on a back portion of the plate portion for establishing pressing contact against the back portion of the connector. The fixing portion receptive of the engaging member is arranged on a front portion of the plate portion. The engaging member is connectable to the multimedia device through the fixing portion. The plate portion and the fixing portion cooperatively define a notch having a cross sectional dimension greater than that of the high definition multimedia interface connector. The retaining device is adaptable on connectors of different specifications, hence, bringing fewer disturbances to users in selection of the connectors.

### BACKGROUND OF THE INSTANT DISCLOSURE

1. Field of the Instant Disclosure

The instant disclosure relates to a retaining device for cable connectors; in particular, to a universal retaining device adaptable for retaining high definition multimedia interface (HDMI) connectors of different sizes.

2. Description of Related Art

The development of high definition televisions has driven the production of the peripheral accessories such as TV decoders, the DVD players, or the storage device for high definition multimedia clips. However, such products often rely on cables for data transmission (such as DVI cable). Furthermore, insecure structural connection between the cable connector and the multimedia device may affect the transmission efficiency and thus the output quality. For instance, the connector may be accidentally loosened or detached from the multimedia device during room cleaning. Furthermore, along with the increasing popularity of wall mounted TV, many multimedia devices have their plugs arranged on the lower peripheral thereof. Therefore, if the frictional force between the connector and the socket of the multimedia device is not strong enough to offset the weight of the cable, the connector may detach and fall due to gravitational force.

Specifically speaking, the connector is a media for electrical connection between the external circuit and the multimedia product. Therefore, in order to strengthen the retaining power of the connector, a conventional retaining device utilizes a screw to fasten the connector to the multimedia device. Nevertheless, the lack of a well integral plan has resulted in a consequence that a single type of retaining device cannot be adapted to all types of connectors. Thus, increasing the expense for manufacture, where the materials for preparation are also more complex.

### SUMMARY OF THE INSTANT DISCLOSURE

The object of the instant disclosure is to provide a cable connector retaining device sleevedly adaptable over a high definition multimedia interface connector to strengthen connection between the connector and a multimedia device.

In order to achieve the aforementioned objects, according to an embodiment of the instant disclosure, the instant disclosure provides a retaining device which includes at least one engaging member and one housing. The housing includes a plate portion, an abutting portion and a fixing portion. By the orientation of the figures, the abutting portion is arranged on a back portion of the plate portion for establishing pressing contact against the back portion of the connector, and fixing portion receptive of the engaging member arranged on a front portion of the plate portion, the engaging member is connectable to the multimedia device through the fixing portion. The plate portion and the fixing portion cooperatively define a notch having a cross sectional dimension greater than that of the high definition multimedia interface connector.

The instant disclosure has the following advantages: the retaining device provided in the instant disclosure strengthens the connection between the connector and the multimedia device. Hence, preventing the connector to detach from the multimedia device, due to loosening, that may affect the signal transmission. Furthermore, the retaining device provided in the instant disclosure is adaptable on connectors of different specifications. Therefore, bringing fewer disturbances to users in selection of the connectors. Moreover, the manufactures can produce through one mold to reduce cost. Yet another, the retaining device of the instant disclosure can be assembled easily. Also, unlike conventional fastening devices that utilizes rough ropes to fasten, the retaining device provided in the instant disclosure is aesthetically appealing with a longer service life.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows an exploded view according to a first embodiment of the instant disclosure;

FIG. 2 shows an assembled view according to a first embodiment of the instant disclosure;

FIG. 3 shows a cross-sectional view according to a first embodiment of the instant disclosure;

FIG. 4 shows a three-dimensional perspective view of a housing according to a second embodiment of the instant disclosure;

FIG. 5 shows a three-dimensional perspective view of a housing according to a third embodiment of the instant disclosure;

FIG. 6 shows a three-dimensional perspective view of a housing according to a fourth embodiment of the instant disclosure;

FIG. 7 shows a three-dimensional perspective view of a housing according to a fifth embodiment of the instant disclosure.

### DETAILED DESCRIPTION OF THE PREFERRED EMBODIMENTS

The instant disclosure provides a retaining device, where the retaining device loads the connector to strengthen the connection between the connector and the multimedia device.

### The First Embodiment

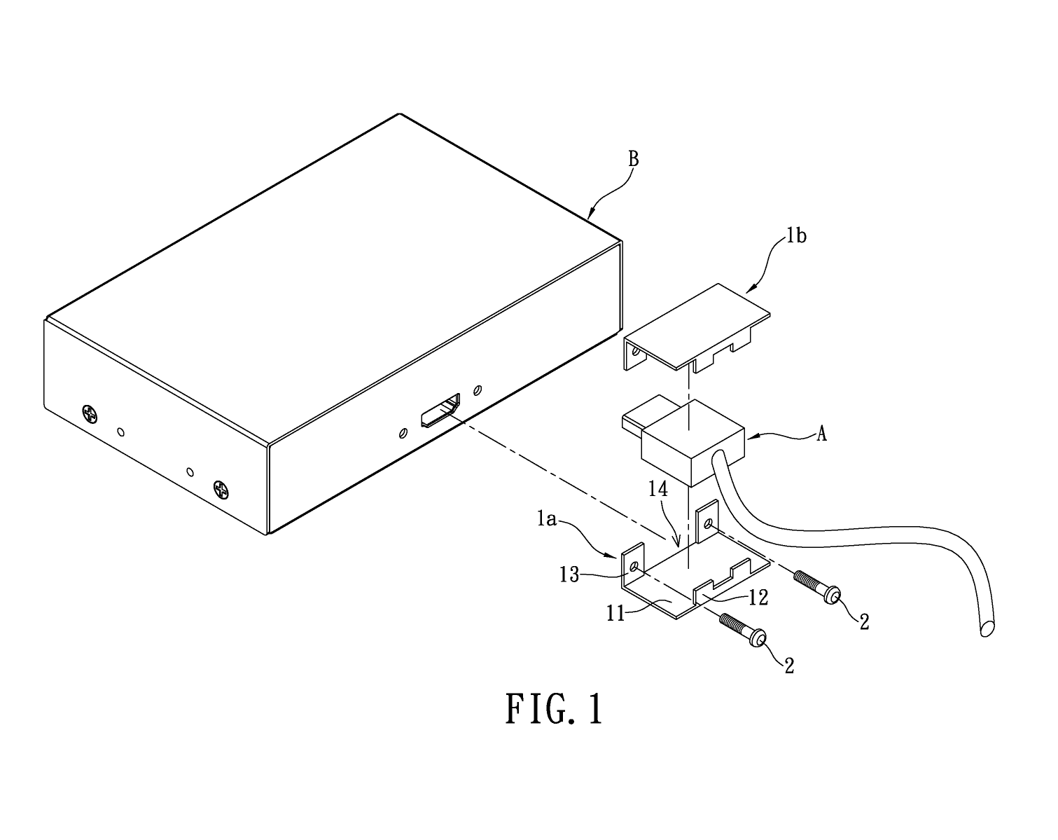

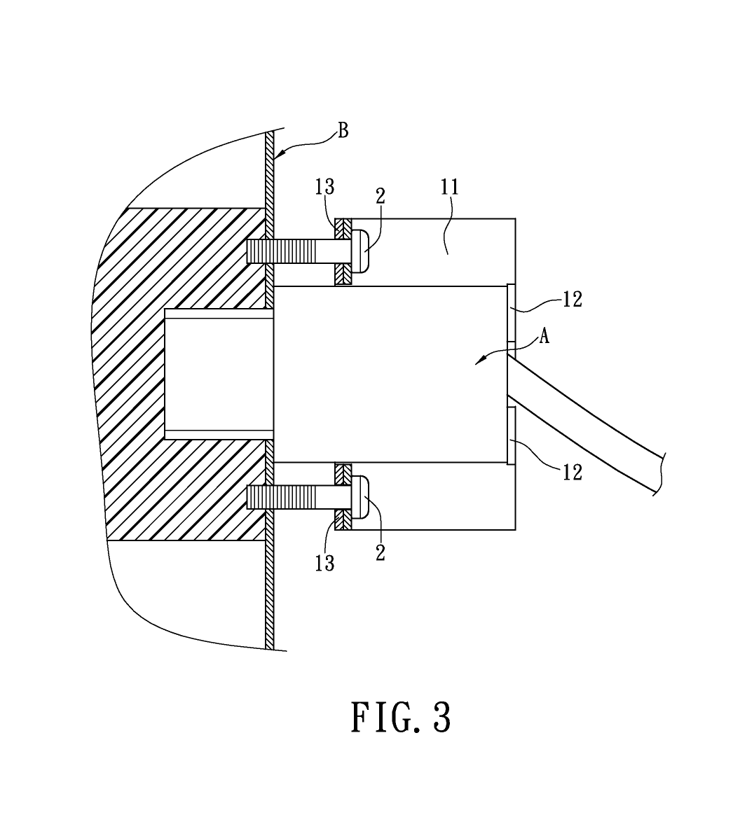

With reference to FIGS. 1-3, the instant disclosure provides a retaining device which includes two engaging members 2 and two housings 1a and 1b. Each of the housings 1a and 1b includes a plate portion 11, an abutting portion 12 and a pair of fixing portions 13. By the orientation of the figures, the abutting portion 12 is arranged on a back portion of the plate portion 11, where the fixing portions 13 are arranged on a front portion of the plate portion 11, and the plate portion 11 and the fixing portions 13 cooperatively define a notch 14 having a cross sectional dimension greater than that of the high definition multimedia interface connector. When the connector A is disposed on the plate portion 11 of the housing 1a, the abutting portion 12 of the housing 1a will abut against the back surface of the connector A, while the connector A has a protrusion (not labeled) arranged on the front portion thereof, will project from the notch 14 of the housing 1a to abut against the surface of the multimedia device B.

To provide further explanations, the plate portion 11 of the other housing 1b will be in contact with the another surface of the connector A, where the abutting portion 12 of the housing 1b will also abut against the back portion of the connector A, and the two fixing portions 13 of the housings 1a and 1b will be adjacently arranged. Preferably, the engaging members 2 of the instant disclosure are screws, where the screws fasten the adjacently arranged fixing portions 13 to the multimedia device B. It is worth noting that since the protrusion (not labeled) of the connector A projects from the notch 14 of the housings 1a and 1b to abut against the multimedia device B, therefore the two housings 1a and 1b may not be in close contact with the multimedia device B. However, the housings 1a and 1b will abut against the connector A. For the instant disclosure, the engaging members 2, such as screws, are utilized for fastening the housings 1a and 1b to the multimedia device B, such that the housings 1a and 1b, and the multimedia device B will be mutually stabilized to strengthen the connection for the connector A.

### The Second Embodiment

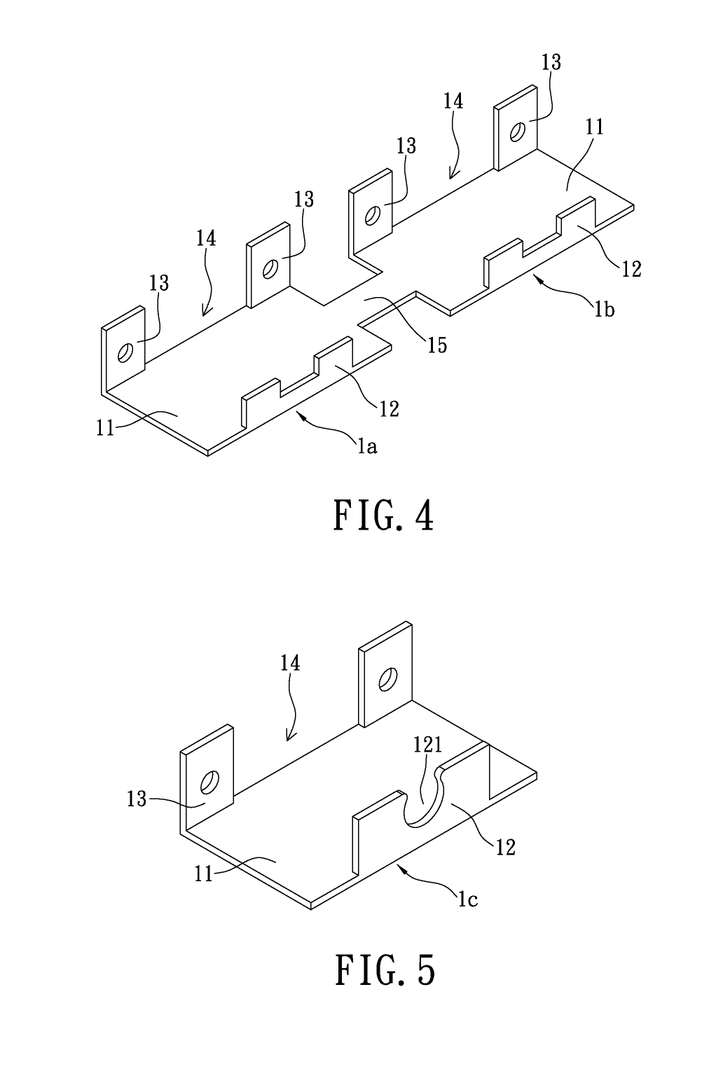

With reference to FIG. 4, the difference between the instant embodiment and the preceding embodiment is that a foldable portion 15 is formed between for connecting the two housings 1a and 1b in the instant embodiment.

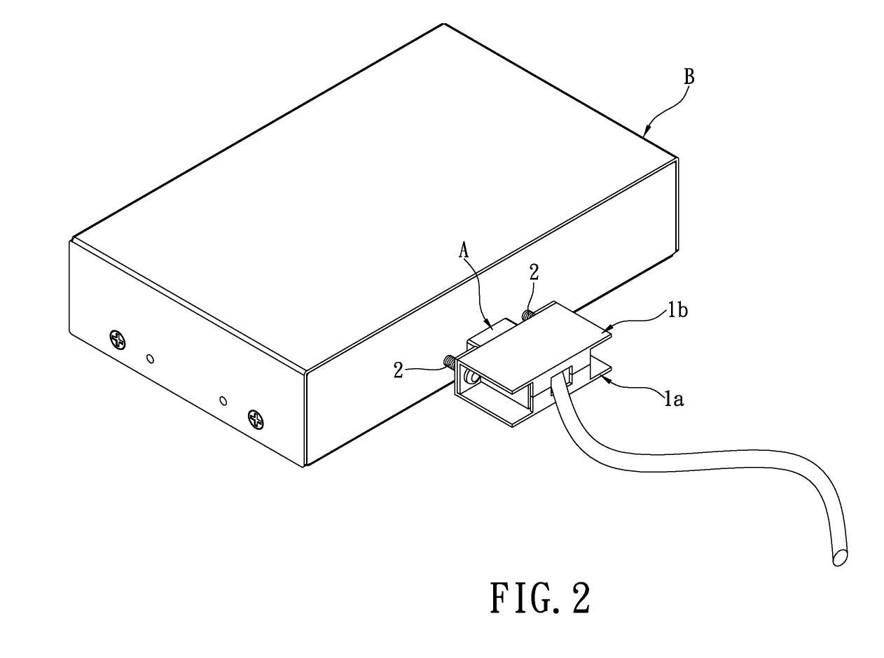

When the connector A (shown in FIG. 2) is disposed in the housing 1a, the other housing 1b can be folded to encase the connector A through bending the foldable portion 15. After the connector A is encased by the two housing 1a and 1b, the fixing portions 13 of the two housings 1a and 1b will be adjacently arranged. Next, the housings 1a and 1b will be screwed to the multimedia device B (shown in FIG. 2) through the engaging member 2, such that the connector A, the housings 1a and 1b, and the multimedia device B will be mutually stabilized to strengthen the connection for the connector A.

### The Third Embodiment

With reference to FIG. 5, the difference between the instant embodiment and the first embodiment is that only one housing 1c is utilized to load the connector A (shown in FIG. 2).

For the housing 1c of the instant embodiment, other than the abutting portion 12 which abuts against one end of the connector A, the abutting portion 12 further has a clutching portion 121 which engages the cables connected at the end of the connector A. Therefore, the connector A will be well-engaged when loaded on the housing 1c. Furthermore, the protrusion (not labeled) of the connector A will be inserted into the multimedia device B (shown in FIG. 2). Thus, the housing 1c will be screwed to the multimedia device B through the fixing portion 13 thereof, such that the connector A, the housings 1c, and the multimedia device B will be mutually stabilized to strengthen the connection for the connector A.

### The Fourth Embodiment

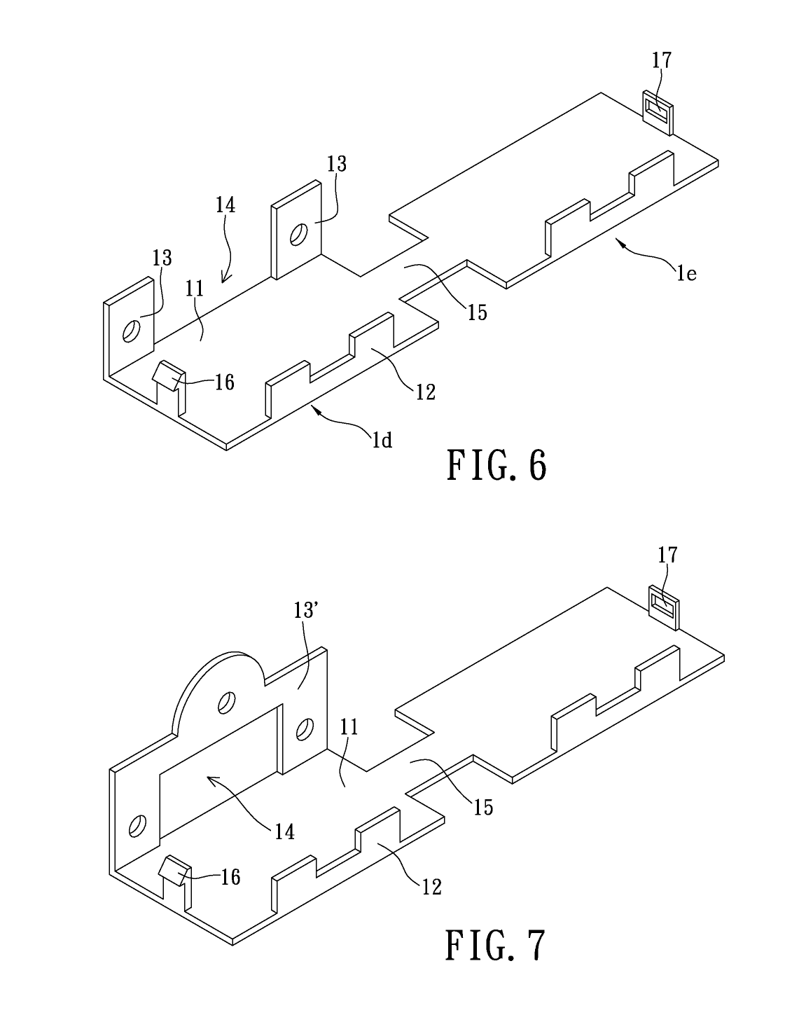

With reference to FIG. 6, the differences between the instant embodiment and the first embodiment are that the housing 1d of the instant embodiment has a first engaging portion 16 formed on one end thereof, and the housing 1e of the instant embodiment does not have the fixing portion 13, however, has a second engaging portion 17 formed on one end thereof.

The connector A (shown in FIG. 2) is loaded on the housing 1d, where the other housing 1e can be folded to encase the connector A through bending the foldable portion 15. In this way, the first and the second engaging portions 16 and 17 can be buttoned together. Furthermore, the housings 1d and 1e are fastened (shown in FIG. 2) by inserting the engaging member 2 through the fixing portion 13 and into the multimedia device B. Therefore, the connector A, the housings 1d and 1e, and the multimedia device B will be mutually stabilized to strengthen the connection for the connector A.

### The Fifth Embodiment

The instant embodiment describes a variation of the fastening portions of the third and the fourth embodiments.

With reference to FIG. 7, generally, the fixing portion 13′ is structurally designed to be in accordance with the multimedia device B, such that the fastening holes formed on the fixing portion 13′ and can align with that of the multimedia device B. Typically, the fastening holes of the multimedia device B are formed on the two respective sides of the slot, or on top of the slot.

Therefore, the instant embodiment provides a three-hole fixing portion 13′, where the holes are formed on the two sides and the top portion of the fixing portion 13′, with respect to the notch 14, where the holes correspond to the fastening holes of the multimedia device B. Thus, the retaining device is capable of affixing to different types of multimedia device B.

### BENEFICIAL EFFECTS OF THE EMBODIMENTS

Based on the above, the instant disclosure has the following advantages: the retaining device provided in the instant disclosure strengthens the connection between the connector and the multimedia device. Hence, preventing the connector to detach from the multimedia device, due to accidental loosening, that may affect the signal transmission. Furthermore, the retaining device provided in the instant disclosure is adaptable on connectors of different specifications. Therefore, bringing fewer disturbances to users in selection of the connectors. Moreover, the manufactures can produce through one mold to reduce cost. Yet another, the retaining device of the instant disclosure can be assembled easily. Also, unlike conventional fastening method which utilizes rough ropes to fasten, the retaining device provided in the instant disclosure is aesthetically appealing with a longer service life.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims

What is claimed is:

1. A cable connector retaining device sleevedly adaptable over a high definition multimedia interface connector to strengthen connection between the connector and a multimedia device, the retaining device comprising:
at least one engaging member; and
a housing, which comprises:
a plate portion,
an abutting portion arranged on a back portion of the plate portion for establishing pressing contact against the back portion of the connector; and
a fixing portion receptive of the engaging member arranged on a front portion of the plate portion, the engaging member is connectable to the multimedia device through the fixing portion;
wherein the plate portion and the fixing portion cooperatively define a notch having a cross sectional dimension greater than that of the high definition multimedia interface connector, thereby allowing the connector to connect to a socket of the multimedia device.

2. The retaining device according to claim 1, further comprising another housing, wherein the connector is encased by the two housings.

3. The retaining device according to claim 2, wherein the fixing portions of the two housings are adjacently arranged such that the two fixing portions are fastened to the media device through the engaging member.

4. The retaining device according to claim 1, wherein the abutting portion has a clutching portion to engage an end portion of the connector.

5. The retaining device according to claim 1, wherein a foldable portion is extended to form between the two housings.

6. The retaining device according to claim 5, wherein the two housings are connected by the foldable portion such that the connector is encased by the two housings.

7. The retaining device according to claim 6, wherein the fixing portions of the two housings are adjacently arranged such that the two fixing portions are fastened to the multimedia device through the engaging member.

8. The retaining device according to claim 5, wherein the housing includes a first engaging portion formed on one end thereof, and the housing does not have the fixing portion, however, has a second engaging portion formed on one end thereof, wherein the first and the second engaging portions are buttoned together when the connector is encased by the housings.

9. The retaining device according to claim 1, wherein the fastening member is selected from the group consisting of screws and rivets.
